(19) United States
(12) Patent Application Publication
(10) Pub. No.: US 2019/0130737 A1
(43) Pub. Date: May 2, 2019

(54) MOTION-BASED MATERIALS MANAGEMENT SYSTEM AND METHOD

(71) Applicant: General Electric Company, Schenectady, NY (US)

(72) Inventors: Philip J. ELLIS, Cleveland, OH (US); Colin D. MCKIBBEN, Cleveland, OH (US)

(21) Appl. No.: 16/151,755

(22) Filed: Oct. 4, 2018

Related U.S. Application Data
(60) Provisional application No. 62/577,664, filed on Oct. 26, 2017.

(51) Int. Cl. G08G 1/04; G08G 1/00; G06Q 50/28

(52) U.S. Cl. CPC G08G 1/04; G06Q 50/28; G08G 1/20

(57) ABSTRACT

A system includes a sensor array that generates movement data of a vehicle and location data indicative of vehicle locations. A controller obtains motion profiles of the vehicle that are based on previous movements of the vehicle. The motion profiles represent sequences of previous movements performed while the vehicle picked up or dropped off objects. The controller monitors the data generated by the sensor array and compares the data with the motion profiles, and determines whether the vehicle picked up or dropped off an object based on a match between the sensor data and the motion profiles. The controller also determines a location of the object where the object was picked up or dropped off based on the match between the sensor data and the motion profiles.

### CROSS-REFERENCE TO RELATED APPLICATIONS

This application claims priority to U.S. Provisional Application No. 62/577,664, which was filed on 26 Oct. 2017, and the entirety of which is incorporated herein by reference.

### BACKGROUND

Materials such as palletized materials or other objects can be moved within a facility using vehicles, such as forklifts or other vehicles. Some facilities can be large and complex buildings with many vehicles concurrently moving materials to different locations. It can be difficult to precisely and consistently track locations of materials as the materials are moved within the facility.

One technique used to track locations of the materials is the use of positioning systems that track locations of the vehicles that move the materials. For example, indoor positioning systems such as visible light communications, wireless beacons, wireless triangulation, and the like, can be used to monitor where vehicles are located in the facility. But, merely knowing where vehicles are located does not reveal or otherwise indicate where the materials being transported by the vehicles are at any given time.

Some facilities will attach beacons or other costly devices to the materials themselves or to supporting structures of the materials (e.g., pallets, boxes, etc.). But, using these additional devices can significantly increase the cost and complexity of the systems used to track locations of the materials in the facility.

### BRIEF DESCRIPTION

In one embodiment, a system includes a sensor array that generates data indicative of movement of a vehicle and indicative of locations of the vehicle while the vehicle picks up or drops off the objects. The system also includes a controller of the vehicle that obtains one or more motion profiles of the vehicle that are based on previous movements of the vehicle. The one or more motion profiles of the vehicle represent one or more sequences of the previous movements performed by the vehicle while the vehicle picks up or drops off objects. The controller monitors the data generated by the sensor array and compares the data with the one or more motion profiles, and determines whether the vehicle picked up or dropped off an object of the objects based on a match between the data from the sensor array and the one or more motion profiles. The controller also determines a location of the object where the object was picked up or dropped off based on the match between the data from the sensor array and the one or more motion profiles.

In one embodiment, a system includes a vehicle location sensor generating location data indicative of vehicle locations of a vehicle inside a facility as the vehicle one or more of picks up or drops off an object, and one or more processors obtaining the location data and determining movement actions of the vehicle inside the facility as the vehicle one or more of picks up or drops off the object. The one or more processors also determine a motion profile of the vehicle based on the movements of the vehicle as the vehicle one or more of picks up or drops off the object. The one or more processors also track one or more event locations in the facility where the object was picked up or dropped off by the vehicle based on both the motion profile of the vehicle and at least one of the vehicle locations. The one or more processors determine an object location of the object in the facility based on the one or more event locations that are tracked.

In one embodiment, a method includes tracking vehicle locations of a vehicle inside a facility as the vehicle one or more of picks up or drops off an object, monitoring movement actions of the vehicle inside the facility as the vehicle one or more of picks up or drops off the object, determining a motion profile of the vehicle based on the movements of the vehicle as the vehicle one or more of picks up or drops off the object, tracking one or more event locations in the facility where the object was picked up or dropped off by the vehicle based on both the motion profile of the vehicle and at least one of the vehicle locations, and identifying an object location of the object in the facility based on the one or more event locations that are tracked.

### BRIEF DESCRIPTION OF THE DRAWINGS

The present inventive subject matter will be better understood from reading the following description of non-limiting embodiments, with reference to the attached drawings, wherein below:

FIG. 1 illustrates operation of one embodiment of a materials management system;

FIG. 2 also illustrates operation of one embodiment of the materials management system shown in FIG. 1;

FIG. 3 also illustrates operation of one embodiment of the materials management system shown in FIGS. 1 and 2;

FIG. 4 also illustrates operation of one embodiment of the materials management system shown in FIGS. 1 through 3;

FIG. 5 illustrates a vehicle shown in FIGS. 1 through 4 according to one embodiment of the inventive subject matter described herein;

FIG. 6 illustrates movements of the vehicle shown in FIG. 1 while picking up an object shown in FIG. 1, and the corresponding motion profile;

FIG. 7 also illustrates movements of the vehicle shown in FIG. 1 while picking up the object shown in FIG. 1, and the corresponding motion profile;

FIG. 8 also illustrates movements of the vehicle shown in FIG. 1 while picking up the object shown in FIG. 1, and the corresponding motion profile;

FIG. 9 also illustrates movements of the vehicle shown in FIG. 1 while picking up the object shown in FIG. 1, and the corresponding motion profile;

FIG. 10 also illustrates movements of the vehicle shown in FIG. 1 while picking up the object shown in FIG. 1, and the corresponding motion profile;

FIG. 11 also illustrates movements of the vehicle shown in FIG. 1 while picking up the object shown in FIG. 1, and the corresponding motion profile;

FIG. 12 illustrates one example of a motion profile for a pick-up event by the vehicle shown in FIG. 1;

FIG. 13 illustrates designated consumption and creation zones within a facility according to one example; and

FIG. 14 illustrates a flowchart of one embodiment of a method for managing the handling of materials in a facility based on motion of vehicles that move the materials.

### DETAILED DESCRIPTION

The inventive subject matter described herein provides systems and methods that determine locations of objects within a facility. The objects can be a variety of materials, such as palletized materials used in a manufacturing facility. Not all embodiments of the inventive subject matter described herein, however, are limited to palletized materials or manufacturing facilities. The locations of the objects can be tracked in an unstructured area of the facility, such as an area that does not have a separate or independent system that independently determines the locations of the objects, such as one or more beacons, wireless triangulation systems, or the like.

The systems and methods can use indoor positioning systems (such as visible light communication, global positioning systems, etc.) to determine locations and headings of vehicles while the vehicles are in motion in the facility. The systems and methods can obtain or determine unique motion profiles for different vehicles and/or different operators of the vehicles. These motion profiles are sequences of movements of the vehicles during interaction events between the vehicles and objects carried by the vehicles. For example, a vehicle and/or an operator of the vehicle may perform the same or similar sequence of movements when the vehicle is used to lift, grasp, or otherwise pick up an object, such as a pallet of material (referred to herein as a pick-up event). Additionally, a vehicle and/or an operator of the vehicle may perform the same or similar sequence of movements when the vehicle is used to lower, release, or otherwise drop off an object, such as a pallet of material (referred to herein as a drop-off event).

The movements (e.g., locations, changes in locations, and/or headings) of the vehicles can be monitored and compared to the motion profiles associated with pick-up and/or drop-off events. If a sequence of movements of a vehicle matches or otherwise corresponds with a pick-up event motion profile, then the systems and methods can determine that an object has been picked up by the vehicle. The location of the vehicle at the time that the pick-up event occurred can be determined, and the systems and methods can determine or otherwise record that the object was picked up from that location (and is no longer present at that location). Similarly, if a sequence of movements of a vehicle matches or otherwise corresponds with a drop-off event motion profile, then the systems and methods can determine that an object has been dropped off by the vehicle. The location of the vehicle at the time that the drop-off event occurred can be determined, and the systems and methods can determine or otherwise record that the object was dropped off at (and is currently located at) that location.

Optionally, additional sensor-provided data or information can be used to more accurately determine when a sequence of movements matches a motion profile and/or to identify the object being picked up or dropped off. The systems and methods can use machine learning to update or improve the accuracy of the sequence of movements that make up a motion profile. For example, the systems and methods can receive operator input that identifies when the vehicle is performing a sequence of movements to pick up an object or when the vehicle is performing a sequence of movements to drop off an object. The systems and methods can compare these movements with the sequence of movements forming a previously created motion profile and update the sequence of movements in the motion profile to more closely match or to include the operator-identified movements.

The identified pick-up and drop-off events can be used by the systems and methods to track the creation and consumption of material through specific material event zones placed on the virtual map of the facility based on where material is picked up and dropped off. For example, determining that a vehicle picked up a pallet of a consumable material within a designated area in the facility may be identified by the systems and methods as a creation event of the material. This area may be the zone where newly created materials in the facility are placed and picked up by vehicles. As another example, determining that a vehicle dropped off a pallet of a consumable material within another designated area in the facility may be identified by the systems and methods as a consumption event of the material. This area may be the zone where materials are taken for consumption in the facility (e.g., for being used in manufacturing, treatment, etc., in the facility).

The systems and methods can coordinate movements of multiple vehicles within the facility with each other using the pick-up and drop-off events that are determined. For example, a first vehicle can have onboard hardware that determines the pick-up and drop-off events, as well as the corresponding locations, for the first vehicle as the first vehicle moves. This onboard hardware of the first vehicle can determine where (and when) the first vehicle picks up a pallet of material from an originating location within the facility. The onboard hardware of the first vehicle can communicate a signal to another, second vehicle to inform the second vehicle that the pallet of material was picked up (and removed) from the originating location. Responsive to receiving this signal, the second vehicle can determine that the originating location is clear of the pallet, and can take another pallet of material to the originating location to replace the pallet picked up by the first vehicle. The onboard hardware of the first vehicle can determine where (and when) the first vehicle drops off the pallet of material at an intermediate or destination location within the facility. The onboard hardware of the first vehicle can communicate a signal to another, third vehicle to inform the third vehicle that the pallet of material was dropped off at the intermediate or destination location. Responsive to receiving this signal, the third vehicle can travel to the intermediate or destination location and pick-up the pallet of material. This can allow for the vehicles to communicate with each other to hand off objects between or among each other.

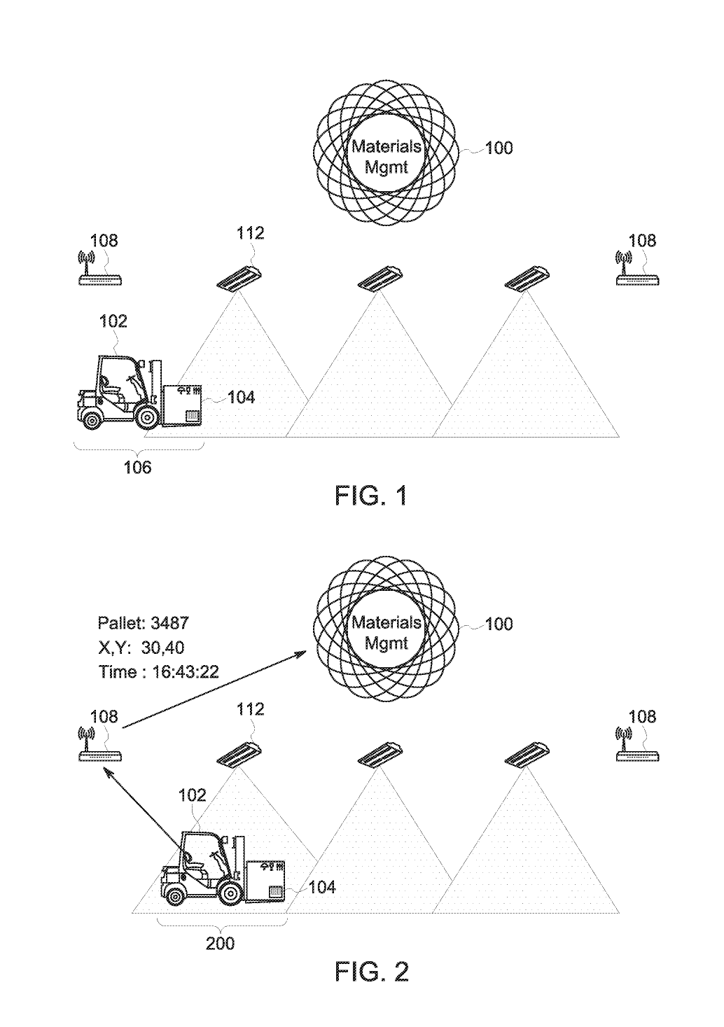

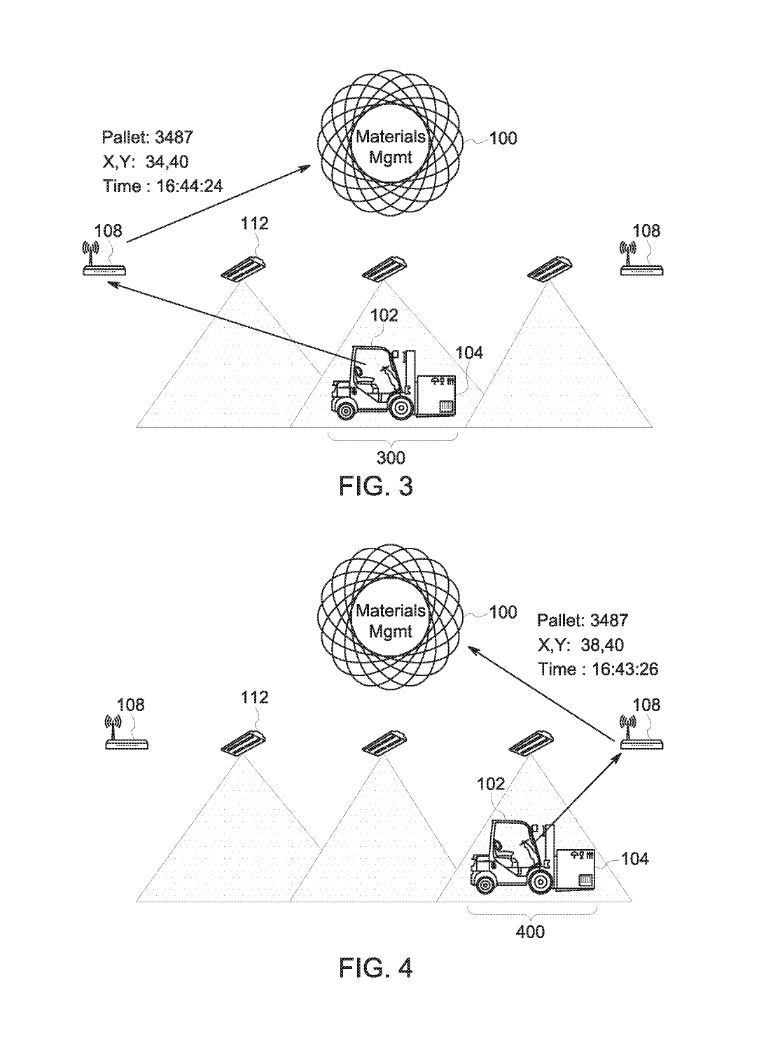

FIGS. 1 through 4 illustrate operation of one embodiment of a materials management system 100. The system 100 is shown as being off-board a vehicle 102, but optionally can be partially or entirely disposed onboard the vehicle 102. The system 100 shown in FIGS. 1 through 4 can represent hardware circuitry that includes and/or is connected with one or more processors (e.g., one or more microprocessors, field programmable gate arrays, integrated circuits, or the like) that communicate with a sensor array onboard the vehicle 102 and/or a controller onboard the vehicle 102 (not shown in FIGS. 1 through 4) to determine and/or track locations of the vehicle 102, pick-up events of objects 104, drop-off events of objects 104, locations of the objects 104, identities of the objects 104, etc. The system 100 can track this information for a variety of vehicles and/or objects within a facility. As described herein, the system 100 can communicate between vehicles 102 so as to coordinate the movements and actions of the vehicles 102 based on locations of the objects 104 and movement events (determined as described herein). Optionally, the vehicles 102 can include components of part or all of the system 100 and communicate directly with each other (e.g., not via or through the system 100 shown in FIGS. 1 through 4) to coordinate the movements and actions of the vehicles 102.

The vehicle 102 is shown as a forklift carrying the object 104 (e.g., a box), but optionally can be another type of vehicle and/or can carry another type of object. The vehicle 102 includes a sensor array (not shown in FIGS. 1 through 4) that sense characteristics of the vehicle 102, characteristics of movements of the vehicle 102, and/or characteristics of the object 104. These characteristics can be used to uniquely identify the object 104 being carried and/or where the object 104 is located.

For example, the vehicle 102 can perform a sequence of movements to pick up the object 104 at a starting location 106. These movements can be compared with a motion profile of the vehicle 102 (and/or of the operator of the vehicle 102) to determine that the vehicle 102 has picked up the object 104 at the starting location 106 (e.g., “X,Y: 30, 40”) at an identified time (e.g., “Time: 16:43:22”). The system 100 optionally can include a sensor onboard the vehicle 102 (not shown in FIGS. 1 through 4) that identifies the object 104 (e.g., as “Pallet: 3487”).

The vehicle 102 can then move in the facility between different locations 200, 300, 400 (shown in FIGS. 2 through 4), with the location of the vehicle 102 and the identified object 104 being determined by a locating system 112 (e.g., a visible light communication system, global positioning system, or the like), and communicated to the system 100 (e.g., via one or more wired and/or wireless networks or network devices 108, such as routers, modems, or the like.). The system 100 can track movement of the vehicle 102 subsequent to identifying the pick-up event of the object 104 by the vehicle 102 in order to determine where the object 104 is located at any given time.

The vehicle 102 can perform another sequence of movements to drop off the object 104 at another location 400. These movements can be compared with another motion profile of the vehicle 102 (and/or of the operator of the vehicle 102) to determine that the vehicle 102 has dropped off the object 104 at the location 400 (e.g., “X,Y: 38, 40”) at a later time (e.g., “Time: 16:43:26”). The system 100 can determine that the object 104 is now located off-board the vehicle 102 at the location 400. The system 100 can track movements of the vehicles 102 in the facility in order to determine when and where the vehicles 102 pick up and drop off the objects 104, thereby allowing the system 100 to automatically track locations and movements of the objects 104 in the facility without having to attach tracking or locating devices to the objects 104.

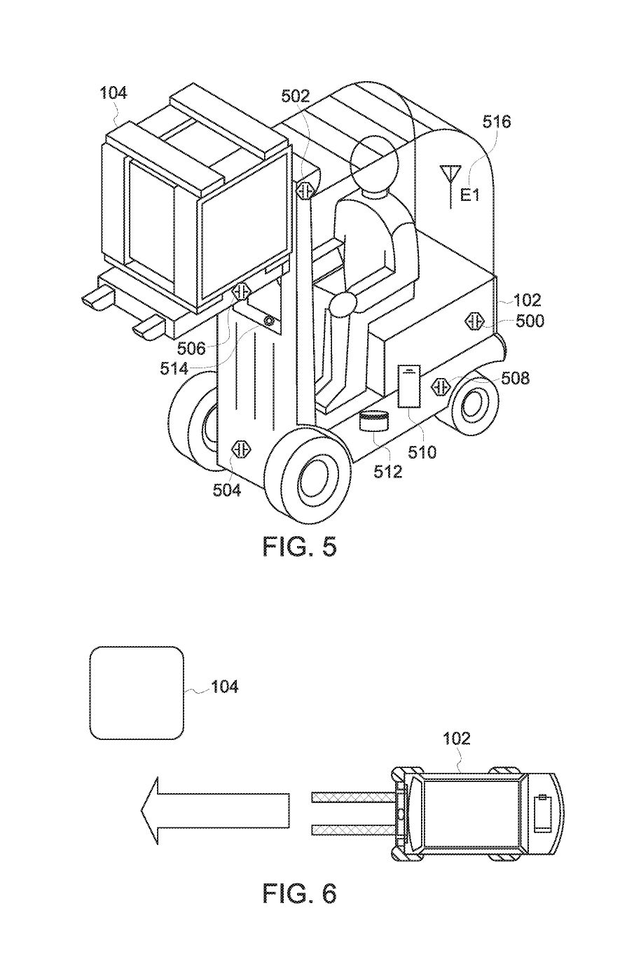

FIG. 5 illustrates the vehicle 102 shown in FIGS. 1 through 4 according to one embodiment of the inventive subject matter described herein. The vehicle 102 can include several components of the system 100 shown in FIGS. 1 through 4 as described herein. The vehicle 102 includes an array of sensor, which can include a vehicle location sensor 500. The vehicle location sensor 500 determines locations of the vehicle 102 and/or generates location data indicative of locations of the vehicle 102. In one embodiment, the vehicle location sensor 500 is a visible light communication sensor that receives wireless communication from one or more lights (e.g., fluorescent lamps) in the facility. This wireless communication can indicate locations within the facility, and can be detected by the vehicle location sensor 500 to determine where the vehicle location sensor 500 (and, therefore, the vehicle 102) is located within the facility. Optionally, the vehicle location sensor 500 can be a global positioning system receiver, a wireless communication device capable of using wireless triangulation to determine the location of the vehicle 102, a receiver of a beacon signal, or the like. The vehicle location sensor 500 can repeatedly determine the location of the vehicle 102 as the vehicle 102 moves in the facility.

The sensor array also can include an identification sensor 502. The identification sensor 502 senses one or more characteristics of the object 104 being picked up, carried, and/or dropped off by the vehicle 102. For example, the identification sensor 502 can detect characteristics of the object 104 and generate identity data that indicates an identity of the object 104. This identity can be a unique identity (e.g., a serial number or the like that is unique to that object 104 and only that object 104) or a non-unique identity (e.g., a model number or the like that is shared by multiple objects 104). The identification sensor 502 can include a radio frequency identification reader that electromagnetically reads the identity of the object 104 from a radio frequency identification tag affixed to the object 104 (or to a pallet on which the object 104 is placed, or the like). Optionally, the identification sensor 502 can include a bar code reader that scans a bar code on the object 104 to determine the identity of the object 104. As another example, the identification sensor 502 can include an optical sensor (such as a camera) that obtains an image or video of the object 104. The identification sensor 502 or a controller (described below) can then examine the image or video to identify the object 104.

The sensor array optionally can include one or more characteristic sensors that output data indicative of one or more characteristics of the vehicle 102 and/or object 104. For example, the sensor array can include a proximity sensor 504 that senses and outputs data indicative of a separation distance between the vehicle 102 and other objects, such as the object 104. The sensor array can include a weight sensor 506 that senses and outputs data indicative of a weight of the object 104. The sensor array optionally can include an accelerometer 508 that senses and outputs data indicative of movement (e.g., acceleration) of the vehicle 102 in one or more directions. Optionally, the sensor array can include one or more other sensors.

A controller 510 onboard the vehicle 102 receives data from the sensor array. The controller 510 represents hardware circuitry that includes and/or is connected with one or more processors that receive sensor data. The controller 510 examines the sensor data and can determine locations of the vehicle 102 and movement actions of the vehicle 102 inside the facility as the vehicle 102 picks up, drops off, and/or carries the object 104. The movement actions can be headings and/or distances traveled by the vehicle 102. Optionally, the controller 510 can be included in the system 100 and located off-board the vehicle 102.

The controller 510 can monitor the movement actions of the vehicle 102 based on changes in the vehicle locations and based one or more additional sensed characteristics of the vehicle 102. For example, the controller 510 can obtain one or more additional sensed characteristics of the vehicle 102 from the proximity sensor 504 (to determine how far the vehicle 102 is from the object 104), from the weight sensor 506 (to determine whether the vehicle 102 is carrying the object 104), from the accelerometer 508 (to more accurately determine movements of the vehicle 102), etc. The controller 510 can temporally map one or more of these additional sensed characteristics with changes in the vehicle locations. For example, the controller 510 can match up movements of the vehicle 102 as measured or sensed by the accelerometer 508 with the changes in the location of the vehicle 102 as determined by or based on data from the location sensor 500. This can result in the controller 510 more accurately defining or determining movement actions of the vehicle 102. For example, the location data from the location sensor 500 may have a relatively large confidence interval or error, and combining the location data with the accelerations measured by the accelerometer 508 can more accurately represent or define the movement actions of the vehicle 102. As another example, a change in heading of the vehicle 102 during a turning movement may not be detected by the location sensor 500 but may be sensed by the accelerometer 508. The accelerometer data generated during or indicative of this turning movement can be saved and used to create or update the motion profile of the vehicle 102, as described below.

The controller 510 can obtain one or more motion profiles associated with the vehicle 102 and/or an operator of the vehicle 102. The motion profiles can be determined (e.g., created, modified, and/or updated) by the controller 510 and/or the system 100. The motion profiles can be locally stored on a tangible and non-transitory computer readable memory 512, such as a hard drive, optical disk, flash drive, or the like, that is accessible by the controller 510.

A motion profile represents a sequence of movements of the vehicle 102 during picking up or dropping off the object 104. FIGS. 6 through 11 illustrate movements of the vehicle 102 while picking up the object 104 and the corresponding motion profile. The movements of the vehicle 102 are determined by the controller 510 based on the data output by the sensors in the sensor array.

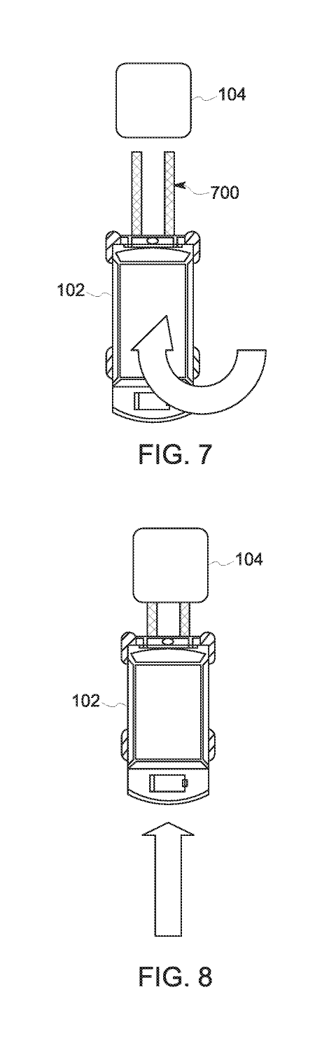

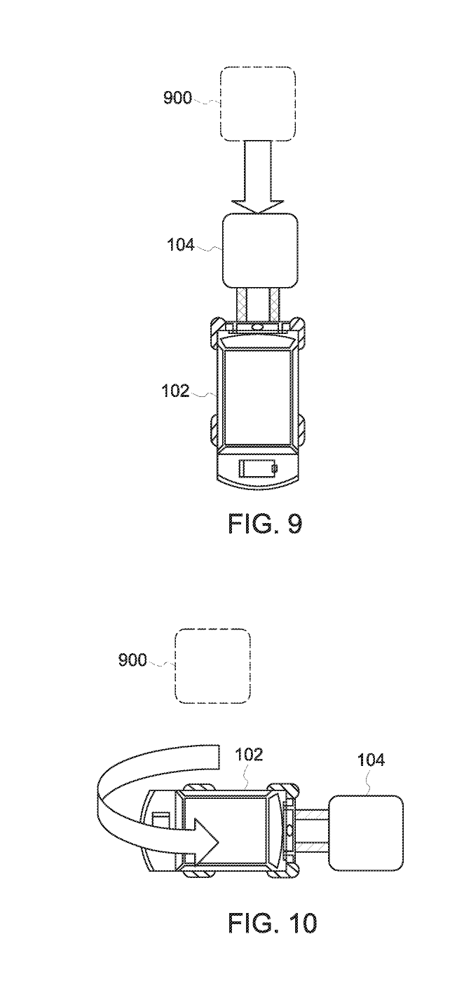

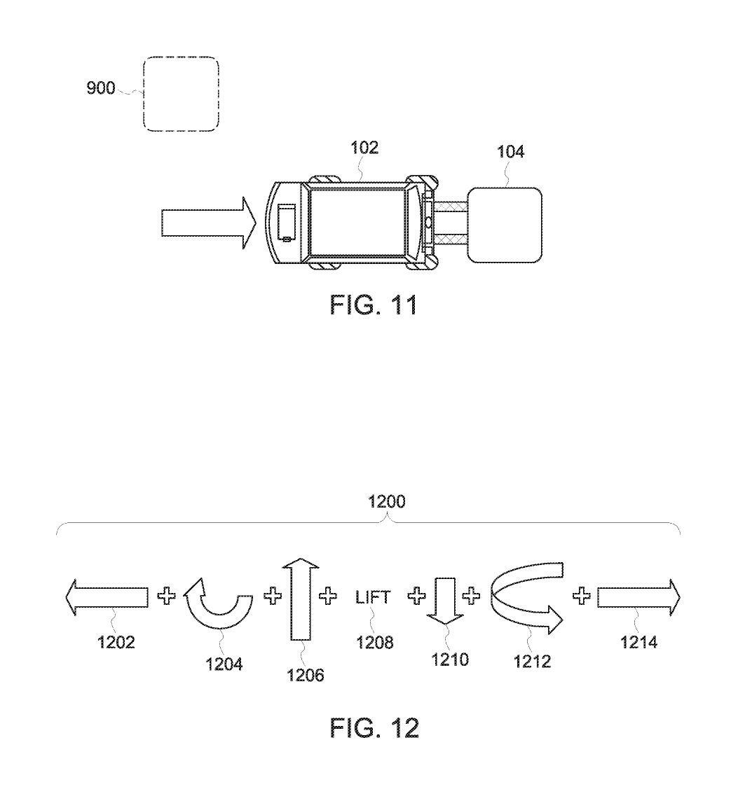

As shown in FIG. 6, the vehicle 102 can initiate the picking up of the object 104 by moving to a position near the object 104. In this example, the vehicle 102 moves to the left in the view of FIG. 6. In FIG. 7, the vehicle 102 turns toward the object 104 so that forks 700 (or another component) of the vehicle 102 face the object 104. The vehicle 102 then moves toward the object 104 to that the forks 700 are below or engaged with the object 104 (shown in FIG. 8). The vehicle 102 can then lift (or otherwise grasp) the object 104, which can be detected by the accelerometer 508 or another sensor. The vehicle 102 then can back away from an original or previous location 900 of the object 104, as shown in FIG. 9. The vehicle 102 then turns (shown in FIG. 10) with the object 104, and moves away from the previous location 900 of the object 104 (shown in FIG. 11). The sensor data representative of the various movements can be stored in the memory 512 and/or communicated to the system 100 via the network devices 108 shown in FIG. 1.

FIG. 12 illustrates one example of a motion profile 1200 for a pick-up event by the vehicle 102. The motion profile 1200 is a sequence of the movements 1202, 1204, 1206, 1208, 1210, 1212, 1214 performed by the vehicle 102 make up or define the motion profile of a pick-up event of the object 104. These movements include the vehicle 102 moving 1202 to the area of the object 104, turning 1204 toward the object 104, moving 1206 to the object 104, lifting 1208 the object 104, backing 1210 away from the previous location 900 of the object 104, turning 1212, and moving 1214 away from the previous location 900 of the object 104. The motion profile 1200 can also include higher resolution information, such as the distances moved during each movement 1202, 1204, 1206, 1208, 1210, 1212, 1214, accelerations during each movement 1202, 1204, 1206, 1208, 1210, 1212, 1214, speed during each movement 1202, 1204, 1206, 1208, 1210, 1212, 1214, and the like. A sequence of similar (or reverse) movements can be performed by the vehicle 102 in dropping off the object 104 and can define a drop-off event of the object 104.

The controller 510 or system 100 can create the motion profile for a pick-up or drop-off event using machine learning. The controller 510 or system 100 can repeatedly modify the motion profile for an event based on movements of the vehicle 102 during several of the same pick-up or drop-off events. For example, the controller 510 or system 100 can examine historical sensor data from several different previous pick-ups of various objects 104 by the same vehicle 102. The sensor data can reveal similar or identical movements by the vehicle 102 across or throughout many or all of the pick-up events. The more often the same or identical movements occur, the more likely the movements are to be included in the motion profile for a pick-up event. The same technique can be performed for determining or modifying the motion profile for a drop-off event.

In one embodiment, an input device 514 is disposed onboard the vehicle 102 and receives input from an operator. The input device 514 can include a button, lever, touchscreen, pedal, switch, or the like. The operator can actuate the input device 514 to indicate that the vehicle 102 is beginning or about to begin a movement event, such as a pick-up or drop-off event. This input from the operator is communicated to the controller 510. Responsive to receiving this input, the controller 510 can begin recording or examining the sensor data so that the sensor data is collected during the pick-up or drop-off event, and is examined to create a motion profile for that event. This can prevent other movements not involved in the pick-up or drop-off event from being mixed up in or used to create a motion profile.

For example, the systems and methods can receive operator input that identifies when the vehicle is performing a sequence of movements to pick up an object or when the vehicle is performing a sequence of movements to drop off an object. The systems and methods can compare these movements with the sequence of movements forming a previously created motion profile and update the sequence of movements in the motion profile to more closely match or to include the operator-identified movements.

The controller 510 or system 100 can modify or update the motion profile for an event if subsequent movements of the vehicle 102 during later pick-up or drop-off events change. For example, if the movements of the vehicle 102 during picking up or dropping off of objects 104 changes over time, these changes can be applied to the corresponding motion profile.

The motion profiles can be unique to a vehicle 102 and/or operator of a vehicle 102. For example, different vehicles 102 may move in different ways during pick-up or drop-off events. A unique, individualized motion profile can be created for a pick-up event for each vehicle 102 and a unique, individualized motion profile can be created for a drop-off event for each vehicle 102. With respect to operators, different operators may control the vehicles 102 in different ways during pick-up or drop-off events. A unique, individualized motion profile can be created for a pick-up event for each operator and a unique, individualized motion profile can be created for a drop-off event for operator.

The motion profiles can be used to determine when the vehicle 102 picks up or drops off another object 104. For example, the controller 510 can monitor the sensor data during operation of the vehicle 102 and can compare the sensor data with the motion profiles. The sensor data can indicate movements of the vehicle 102, and the controller 510 can determine if any sequence of movements represented by the sensor data matches or otherwise corresponds to the sequence of movements defined by the motion profile. If the movements represented by the sensor data match or correspond with the movements that define a motion profile associated with a pick-up event for a vehicle 102 and/or operator, then the controller 510 can determine that a pick-up event has occurred. The controller 510 can then examine the location data from the location sensor 500 to determine where the pick-up event occurred. Similarly, if the movements represented by the sensor data match or correspond with the movements that define a motion profile associated with a drop-off event for a vehicle 102 and/or operator, then the controller 510 can determine that a drop-off event has occurred. The controller 510 can then examine the location data from the location sensor 500 to determine where the drop-off event occurred.

In one embodiment, the movements represented by the sensor data may not exactly match the sequence of movements that define a motion profile. The controller 510 can calculate confidence intervals for pick-up or drop-off events. The confidence intervals can indicate how closely the sensed movements match or correspond with the sequence of movements in a motion profile. Larger confidence intervals can indicate that the pick-up or drop-off event associated with a motion profile is more likely to have occurred, while smaller confidence intervals can indicate that the pick-up or drop-off event associated with a motion profile is less likely to have occurred.

The detected pick-up and/or drop-off events identified by the controller 510 can be stored in the memory 512 and/or communicated to the system 100 via the network devices 108 (or in another manner). The vehicle 102 can include a communication device 516, such as transceiving or transmitting circuitry and associated hardware (e.g., an antenna), that communicates the detected events and corresponding vehicle locations to the system 100.

The system 100 can track locations of the objects 104 throughout the facility based on where the pick-up and drop-off events are detected as occurring. Optionally, the system 100 can track locations of the objects 104 in real time (e.g., as the objects 104 are being moved from a pick-up location to a drop-off location) by identifying a pick-up event and monitoring the changing location of the vehicle 102 carrying the object 104 as the vehicle 102 moves in the facility.

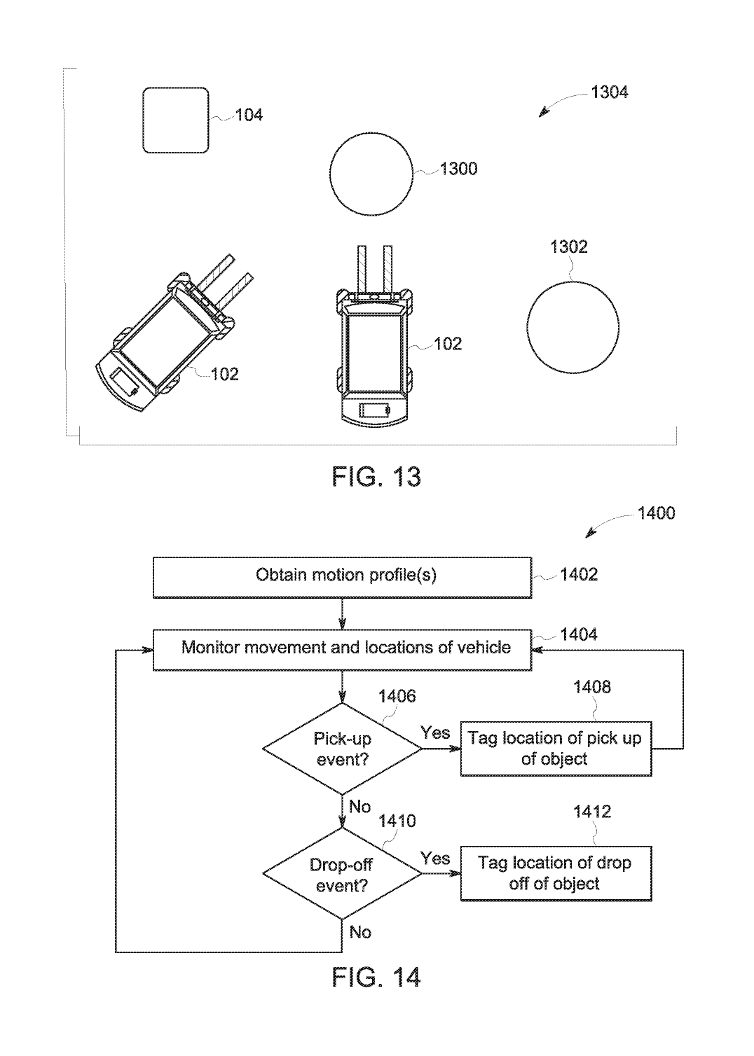

In one embodiment, the system 100 and/or controller 510 can determine that a consumption event and/or a creation event of the object 104 has occurred based on where a pick-up or drop-off event occurs. FIG. 13 illustrates designated consumption and creation zones 1300, 1302 within a facility 1304 according to one example. The facility 1304 can be a building (or series of connected buildings), and the zones 1300, 1302 can be designated areas in the facility 1304. The vehicles 102 can move within the facility 1304 with picking up, moving, and dropping off the objects 104 in various locations in the facility 1304.

The zones 1300, 1302 may be geofenced areas that, when a pick-up or drop-off event occurs within the zones 1300, 1302, the controller 510 or system 100 determines that the object 104 has been consumed or created. For example, the zone 1300 may be a designated consumption zone. If a drop-off event is identified as occurring within the consumption zone 1300, the system 100 or controller 510 can determine that the object 104 that was dropped off in the consumption zone 1300 has been consumed or otherwise used (e.g., in the manufacture of a component or equipment). The system 100 or controller 510 can then eliminate that object 104 from an inventory of objects 104 within the facility 1304.

The zone 1302 may be a designated creation zone. If a pick-up or drop-off event is identified as occurring within the creation zone 1302, the system 100 or controller 510 can determine that the object 104 that was picked up or dropped off in the creation zone 1302 has been created (e.g., from other materials). The system 100 or controller 510 can then add that object 104 to an inventory of objects 104 within the facility 1304.

In one embodiment, the controller 510 can communicate with other vehicles 102 to coordinate movements of the vehicles 102 with each other. For example, the controller 510 onboard a first vehicle 102 can communicate an instructional signal to a second vehicle 102. This instructional signal can inform the second vehicle 102 that the first vehicle 102 has picked up or dropped off the object 104 and/or the location at which the pick-up event or drop-off event occurred. Based on this instructional signal, the second vehicle 102 may perform one or more actions, such as automatically move to a location of a drop-off event to pick up the object 104 (that was subject to the drop-off event by the first vehicle 102), to a location of a pick-up event to drop off another object 104, or the like.

The movements of the vehicles 102 can be coordinated to provide for one vehicle 102 handing off an object 104 to another vehicle 102. For example, the first vehicle 102 can take the object 104 to a location and drop off the object 104. Responsive to detecting the drop-off event of the object 104, the controller 510 onboard the first vehicle 102 can communicate the instructional signal to the second vehicle 102. The second vehicle 102 receives the signal and moves to the location associated with the drop-off event. The second vehicle 102 then picks up the object 104 and carries the object 104 to another location. In this way, the movements of many vehicles 102 can be coordinated with each other to more accurately and quickly move objects 104 throughout the facility 1304.

FIG. 14 illustrates a flowchart of one embodiment of a method 1400 for managing the handling of materials in a facility based on motion of vehicles that move the materials. The method 1400 can represent the operations performed by the system 100 and/or controller 510. At 1402, one or more motion profiles are obtained. The motion profiles can be obtained by the controller 510 from the onboard memory device 512 and/or from the off-board system 100. At 1404, movement and locations of the vehicle 102 are monitored. The controller 510 can monitor movements and locations of the vehicle 102 using sensor data from the sensor array.

At 1406, a determination is made as to whether a pick-up event is detected or has occurred. For example, the controller 510 can compare movements of the vehicle 102 with movements forming or defining a motion profile of a pick-up event associated with the vehicle 102 and/or operator of the vehicle 102. If the movements of the vehicle 102 match or correspond with the movements defining the motion profile associated with the pick-up event, then a pick-up event is detected. As a result, flow of the method 1400 can proceed toward 1408. But, if the movements of the vehicle 102 do not match or correspond with the movements that define the pick-up event motion profile, then flow of the method 1400 can proceed toward 1410.

At 1408, a location of the vehicle 102 (e.g., during the pick-up event detected at 1406) is identified as the location of the object 104 that was picked up by the vehicle 102 during the pick-up event. This object location can be tagged or saved in a memory (e.g., the memory device 512 or another memory device of the system 100) to allow for automated tracking of locations of objects 104 throughout a facility. Flow of the method 1400 can then return toward 1404, may return to another operation, or may terminate.

At 1410, a determination is made as to whether a drop-off event is detected or has occurred. For example, the controller 510 can compare movements of the vehicle 102 with movements forming or defining a motion profile of a drop-off event associated with the vehicle 102 and/or operator of the vehicle 102. If the movements of the vehicle 102 match or correspond with the movements defining the motion profile associated with the drop-off event, then a drop-off event is detected. As a result, flow of the method 1400 can proceed toward 1412. But, if the movements of the vehicle 102 do not match or correspond with the movements that define the drop-off event motion profile, then flow of the method 1400 can return toward 1404, may return to another operation, or may terminate.

At 1412, a location of the vehicle 102 (e.g., during the drop-off event detected at 1410) is identified as the location of the object 104 that was dropped off by the vehicle 102 during the drop-off event. This object location can be tagged or saved in a memory (e.g., the memory device 512 or another memory device of the system 100) to allow for automated tracking of locations of objects 104 throughout a facility.

In one embodiment, a system includes a sensor array that generates data indicative of movement of a vehicle and indicative of locations of the vehicle while the vehicle picks up or drops off the objects. The system also includes a controller of the vehicle that obtains one or more motion profiles of the vehicle that are based on previous movements of the vehicle. The one or more motion profiles of the vehicle represent one or more sequences of the previous movements performed by the vehicle while the vehicle picks up or drops off objects. The controller monitors the data generated by the sensor array and compares the data with the one or more motion profiles, and determines whether the vehicle picked up or dropped off an object of the objects based on a match between the data from the sensor array and the one or more motion profiles. The controller also determines a location of the object where the object was picked up or dropped off based on the match between the data from the sensor array and the one or more motion profiles.

Optionally, the controller determines the location of the object within an unstructured area of a facility. The unstructured area of the facility includes an area without one or more sensors or systems that independently determine the object location without the one or more motion profiles of the vehicle or the data from the sensor array.

Optionally, the controller is disposed onboard the vehicle and the controller determines the one or more motion profiles based on the previous movements of the vehicle.

Optionally, the sensor array includes an identification sensor that determines an identity of the object by one or more of optically or electromagnetically scanning the object.

Optionally, the controller communicates the identity of the object and the location of the object to an off-board monitor device that tracks different locations of different objects that include the object within a facility.

Optionally, the data generated by the sensor array also indicates one or more additional characteristics of the vehicle. The controller determines whether the vehicle picked up or dropped off the object by temporally mapping the one or more additional characteristics of the vehicle with the movements of the vehicle.

Optionally, the sensor array also includes one or more of a proximity sensor that outputs the data indicative of a proximity of the vehicle to the object as the one or more additional characteristics, a weight sensor that outputs the data indicative of a weight of the object as the one or more additional characteristics, and/or an optical sensor that outputs the data indicative of an image or video of the object as the one or more additional characteristics.

Optionally, the controller determines the motion profile using machine learning by modifying the motion profile based on subsequent movements of the vehicle during one or more of subsequent pickups or subsequent drop offs of other objects.

Optionally, the system also includes an input device that receives operator input that is indicative of one or more upcoming movements of the movements of the vehicle during one or more of picking up or dropping off other objects. The one or more processors determine the motion profile based on the operator input and the one or more upcoming movements that are identified by the operator input.

Optionally, the controller determines the motion profile as being unique to the vehicle.

Optionally, the controller determines the motion profile as being unique to an operator of the vehicle.

Optionally, the controller determines one or more of a consumption event or a creation event of the object based on which area of several areas includes the location of the object that was determined.

Optionally, the controller communicates instructional signals to one or more other vehicles based on the location of where the object was picked up or dropped off.

Optionally, the controller coordinates movements of the vehicle and the one or more other vehicles using the instructional signals so that the object can be handed off between the vehicle and at least one of the other vehicles.

In one embodiment, a system includes a vehicle location sensor generating location data indicative of vehicle locations of a vehicle inside a facility as the vehicle one or more of picks up or drops off an object, and one or more processors obtaining the location data and determining movement actions of the vehicle inside the facility as the vehicle one or more of picks up or drops off the object. The one or more processors also determine a motion profile of the vehicle based on the movements of the vehicle as the vehicle one or more of picks up or drops off the object. The one or more processors also track one or more event locations in the facility where the object was picked up or dropped off by the vehicle based on both the motion profile of the vehicle and at least one of the vehicle locations. The one or more processors determine an object location of the object in the facility based on the one or more event locations that are tracked.

Optionally, the one or more processors determine the object location in the facility within an unstructured area of the facility. The unstructured area of the facility includes an area without one or more sensors or systems that independently determine the object location without the motion profile of the vehicle.

Optionally, the one or more processors are disposed onboard the vehicle.

Optionally, the system also includes an identification sensor that determines an identity of the object during the movement actions of the vehicle inside the facility as the vehicle one or more of picks up or drops off the object.

Optionally, the identification sensor includes one or more of a radio frequency identification reader, a bar code reader, and/or a camera.

Optionally, the one or more processors monitor the movement actions of the vehicle based on changes in the vehicle locations that are tracked and based one or more additional sensed characteristics of the vehicle.

Optionally, the one or more processors monitor the movement actions of the vehicle by obtaining the one or more additional sensed characteristics of the vehicle and temporally mapping the one or more additional sensed characteristics of the vehicle with the changes in the vehicle locations.

Optionally, the system also includes one or more characteristic sensors that output data indicative of the one or more characteristics of the vehicle. The one or more characteristic sensors include one or more of a proximity sensor that outputs the data indicative of a proximity of the vehicle to the object, a weight sensor that outputs the data indicative of a weight of the object, and/or an optical sensor that outputs the data indicative of an image or video of the object.

Optionally, the motion profile represents a sequence of a subset of the movements of the vehicle during the one or more of picking up or dropping off the object.

Optionally, the one or more processors determine the motion profile using machine learning by repeatedly modifying the motion profile based on subsequent movements of the vehicle during one or more of subsequent pickups or subsequent drop offs of other objects.

Optionally, the system also includes a memory device that is accessible by the one or more processors to obtain stored data that is indicative of historical movements of the vehicle during one or more of picking up or dropping off other objects. The one or more processors determine the motion profile based on the historical movements.

Optionally, the system also includes an input device that receives operator input that is indicative of one or more upcoming movements of the movements of the vehicle during one or more of picking up or dropping off other objects. The one or more processors determine the motion profile based on the operator input and the one or more upcoming movements that are identified by the operator input.

Optionally, the one or more processors determine the motion profile as being unique to the vehicle.

Optionally, the one or more processors determine different motion profiles for different vehicles.

Optionally, the one or more processors determine the motion profile as being unique to an operator of the vehicle.

Optionally, the one or more processors determine different motion profiles for different operators.

Optionally, the one or more processors determine one or more of a consumption event or a creation event of the object based on an area in the facility in which the one or more event locations are tracked.

Optionally, the system also includes a communication device that communicates instructional signals with one or more other separate vehicles. The one or more processors generate and direct the communication device to communicate at least one of the instructional signals based on the one or more event locations to inform at least one of the other separate vehicles that the object is at the object location.

Optionally, the one or more processors coordinate movements of the vehicle and the at least one other separate vehicle based on the one or more event locations that are determined and using the at least one of the instructional signals.

In one embodiment, a method includes tracking vehicle locations of a vehicle inside a facility as the vehicle one or more of picks up or drops off an object, monitoring movement actions of the vehicle inside the facility as the vehicle one or more of picks up or drops off the object, determining a motion profile of the vehicle based on the movements of the vehicle as the vehicle one or more of picks up or drops off the object, tracking one or more event locations in the facility where the object was picked up or dropped off by the vehicle based on both the motion profile of the vehicle and at least one of the vehicle locations, and identifying an object location of the object in the facility based on the one or more event locations that are tracked.

Optionally, the object location in the facility is identified within an unstructured area of the facility. The unstructured area of the facility includes an area without one or more sensors or systems that independently determine the object location without the motion profile of the vehicle.

Optionally, tracking the vehicle locations, monitoring the movement actions of the vehicle, determining the motion profile of the vehicle, tracking the one or more event locations, and identifying the object location of the object in the facility is performed by one or more processors disposed onboard the vehicle.

Optionally, tracking the vehicle locations, monitoring the movement actions of the vehicle, tracking the one or more event locations, and identifying the object location of the object in the facility is performed by one or more processors disposed onboard the vehicle.

Optionally, the method also includes sensing an identification of the object during the movement actions of the vehicle inside the facility as the vehicle one or more of picks up or drops off the object.

Optionally, the movement actions of the vehicle are monitored based on changes in the vehicle locations that are tracked and based one or more additional sensed characteristics of the vehicle.

Optionally, the movement actions of the vehicle are monitored by temporally mapping sensing of the one or more additional sensed characteristics of the vehicle with the changes in the vehicle locations.

Optionally, the one or more additional sensed characteristics of the vehicle include a proximity of the vehicle to the object as sensed by a proximity sensor, a weight of the object as sensed by a weight sensor, and/or an identity of the object as determined from output of an optical sensor.

Optionally, the motion profile represents a sequence of a subset of the movements of the vehicle during the one or more of picking up or dropping off the object.

Optionally, the motion profile is determined using machine learning that repeatedly modifies the motion profile based on subsequent movements of the vehicle during one or more of subsequent pickups or subsequent drop offs of other objects.

Optionally, the motion profile is determined based on historical movements of the vehicle during one or more of picking up or dropping off other objects.

Optionally, the motion profile is determined based on an operator-identified subset of the movements of the vehicle during one or more of picking up or dropping off other objects.

Optionally, the motion profile is unique to the vehicle.

Optionally, the motion profile is unique to an operator of the vehicle.

Optionally, the method also includes determining one or more of a consumption event or a creation event of the object based on an area in the facility in which the one or more event locations are tracked.

Optionally, the method also includes coordinating movements of the vehicle and at least one additional vehicle in order to hand off the object from the vehicle to the at least one additional vehicle based on the object location that is identified.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a sensor array that generates data indicative of movement of a vehicle and indicative of locations of the vehicle while the vehicle picks up or drops off objects; and
a controller of the vehicle that obtains one or more motion profiles of the vehicle that are based on previous movements of the vehicle, the one or more motion profiles of the vehicle representing one or more sequences of the previous movements performed by the vehicle while the vehicle picks up or drops off objects,
wherein the controller monitors the data generated by the sensor array and compares the data with the one or more motion profiles, the controller determining whether the vehicle picked up or dropped off an object of the objects based on a match between the data from the sensor array and the one or more motion profiles, the controller also determining a location of the object where the object was picked up or dropped off based on the match between the data from the sensor array and the one or more motion profiles.

2. The system of claim 1, wherein the controller determines the location of the object within an unstructured area of a facility, the unstructured area of the facility including an area without one or more sensors or systems that independently determine the object location without the one or more motion profiles of the vehicle or the data from the sensor array.

3. The system of claim 1, wherein the controller is disposed onboard the vehicle and the controller determines the one or more motion profiles based on the previous movements of the vehicle.

4. The system of claim 1, wherein the sensor array includes an identification sensor that determines an identity of the object by one or more of optically or electromagnetically scanning the object.

5. The system of claim 4, wherein the controller communicates the identity of the object and the location of the object to an off-board monitor device that tracks different locations of different objects that include the object within a facility.

6. The system of claim 1, wherein the data generated by the sensor array also indicates one or more additional characteristics of the vehicle, and wherein the controller determines whether the vehicle picked up or dropped off the object by temporally mapping the one or more additional characteristics of the vehicle with the movements of the vehicle.

7. The system of claim 6, wherein the sensor array also includes one or more of a proximity sensor that outputs the data indicative of a proximity of the vehicle to the object as the one or more additional characteristics, a weight sensor that outputs the data indicative of a weight of the object as the one or more additional characteristics, or an optical sensor that outputs the data indicative of an image or video of the object as the one or more additional characteristics.

8. A system comprising:
a vehicle location sensor generating location data indicative of vehicle locations of a vehicle inside a facility as the vehicle one or more of picks up or drops off an object; and
one or more processors obtaining the location data and determining movement actions of the vehicle inside the facility as the vehicle one or more of picks up or drops off the object, the one or more processors also determining a motion profile of the vehicle based on the movements of the vehicle as the vehicle one or more of picks up or drops off the object,
wherein the one or more processors also track one or more event locations in the facility where the object was picked up or dropped off by the vehicle based on both the motion profile of the vehicle and at least one of the vehicle locations, the one or more processors determining an object location of the object in the facility based on the one or more event locations that are tracked.

9. The system of claim 8, wherein the one or more processors determine the object location in the facility within an unstructured area of the facility, the unstructured area of the facility including an area without one or more sensors or systems that independently determine the object location without the motion profile of the vehicle.

10. The system of claim 8, further comprising an identification sensor that determines an identity of the object during the movement actions of the vehicle inside the facility as the vehicle one or more of picks up or drops off the object.

11. The system of claim 8, wherein the one or more processors monitor the movement actions of the vehicle based on changes in the vehicle locations that are tracked and based one or more additional sensed characteristics of the vehicle.

12. The system of claim 11, wherein the one or more processors monitor the movement actions of the vehicle by obtaining the one or more additional sensed characteristics of the vehicle and temporally mapping the one or more additional sensed characteristics of the vehicle with the changes in the vehicle locations.

13. The system of claim 11, further comprising one or more characteristic sensors that output data indicative of the one or more characteristics of the vehicle, the one or more characteristic sensors including one or more of a proximity sensor that outputs the data indicative of a proximity of the vehicle to the object, a weight sensor that outputs the data indicative of a weight of the object, or an optical sensor that outputs the data indicative of an image or video of the object.

14. The system of claim 8, wherein the motion profile represents a sequence of a subset of the movements of the vehicle during the one or more of picking up or dropping off the object.

15. The system of claim 14, wherein the one or more processors determine the motion profile using machine learning by repeatedly modifying the motion profile based on subsequent movements of the vehicle during one or more of subsequent pickups or subsequent drop offs of other objects.

16. A method comprising:
tracking vehicle locations of a vehicle inside a facility as the vehicle one or more of picks up or drops off an object;
monitoring movement actions of the vehicle inside the facility as the vehicle one or more of picks up or drops off the object;
determining a motion profile of the vehicle based on the movements of the vehicle as the vehicle one or more of picks up or drops off the object;
tracking one or more event locations in the facility where the object was picked up or dropped off by the vehicle based on both the motion profile of the vehicle and at least one of the vehicle locations; and
identifying an object location of the object in the facility based on the one or more event locations that are tracked.

17. The method of claim 16, wherein the object location in the facility is identified within an unstructured area of the facility, the unstructured area of the facility including an area without one or more sensors or systems that independently determine the object location without the motion profile of the vehicle.

18. The method of claim 16, wherein tracking the vehicle locations, monitoring the movement actions of the vehicle, determining the motion profile of the vehicle, tracking the one or more event locations, and identifying the object location of the object in the facility is performed by one or more processors disposed onboard the vehicle.

19. The method of claim 16, wherein tracking the vehicle locations, monitoring the movement actions of the vehicle, tracking the one or more event locations, and identifying the object location of the object in the facility is performed by one or more processors disposed onboard the vehicle.

20. The method of claim 16, further comprising sensing an identification of the object during the movement actions of the vehicle inside the facility as the vehicle one or more of picks up or drops off the object.
